(19) United States
(12) Patent Application Publication
(10) Pub. No.: US 2008/0197254 A1
(43) Pub. Date: Aug. 21, 2008

(54) Angle Adjustable Stopwatch Supporter

(76) Inventor: Shih-hung Hsu, Taichung Hsien (TW)

Correspondence Address: Dr. BANGER SHIA, 102 Lindencrest Ct., Sugar Land, TX, 77479-5201, US

(21) Appl. No.: 11/676,290

(22) Filed: Feb. 17, 2007

(51) Int. Cl. G09F 7/18

(52) U.S. Cl. 248/230.5

(57) ABSTRACT

An angle adjustable stopwatch supporter comprises a fastening seat, a fixed seat, a sleeve and an end cap. The fixed shaft is utilized to position the sleeve and the end cap on the fastening seat. Each end of the sleeve is formed with an arc structure; likewise, the fastening seat and the end cap are formed with an arc structure respectively. In such a manner that the arc structures at both ends of the sleeve are engaged with the arc structures of the fastening seat and the end cap respectively, thus achieving the objective that the axial displacement angle can be adjusted between the fastening seat and the end cap.

### BACKGROUND OF THE INVENTION

1. Field of the Invention

The present invention relates to a stopwatch supporter, and more particularly to an angle adjustable stopwatch supporter.

2. Description of the Prior Art

Conventionally, an alarm bell was mounted on the handlebar of a bicycle for safety; afterwards, with the development of the bicycle, a derailleur was mounted on the handlebar in order to change the chain ring according to the road conditions. Up to the present, the players of the bike competition have found that there is no enough time to notice the time on the wristwatch during riding, so a stopwatch is considered to mount on the bicycle to facilitate the riders to notice the time during the racing or training, thus controlling the speed.

Accordingly, referring to FIG. 1, a conventional stopwatch supporter for a bicycle developed on the market comprises a fastening seat 10, a fixed shaft 11, a sleeve 12 and an end cap 13. The fastening seat 10 is positioned on the handlebar of the bicycle, one end of the fixed shaft 11 which is inserted into the fastening seat 10 is also inserted through the sleeve 12 to assemble with the end cap 13, thus positioning the sleeve 12 between the fastening seat 10 and the end cap 13. In such a manner, a stopwatch can be mounted on the sleeve 12, in order that the players can notice the time during the racing.

The conventional stopwatch supporter appears to be convenient, however, it will have the shortcomings when assembled with the stopwatch. Since outer surface of the stopwatch is flat and smooth, when the players pass the road section where the sun is shining, the surface of the stopwatch will reflect the light. The players will wear sunglasses to avoid the glare of the reflected sunlight, but they can not see what is shown on the stopwatch distinctly. Surely, the player can rotate the angle of the stopwatch mounted on the stopwatch supporter, but it will cause the surface of the stopwatch to be out of the line of sight. So it is still difficult for the players to see what is shown on the stopwatch distinctly. Consequently, rotating the stopwatch is just a stopgap method; and finding out a method to solve the reflection problem absolutely is the permanent cure.

The present invention has arisen to mitigate and/or obviate the afore-described disadvantages.

### SUMMARY OF THE INVENTION

An angle adjustable stopwatch supporter in accordance with the present invention is provided for achieving the objective that the axial displacement angle of a sleeve can be adjusted between a fastening seat and an end cap by engaging two arc structures at both ends of the sleeve with an arc structure of the fastening seat and an arc structure of the end cap respectively.

In order to achieve the above objective, the angle adjustable stopwatch supporter in accordance with the present invention comprises a fastening seat, a fixed shaft, a sleeve and an end cap. The fastening seat is mounted on a handlebar of a bicycle; the fixed shaft is inserted through the fastening seat and the sleeve to position the sleeve between the fastening seat and the end cap and assembled with the end cap, each end of the sleeve is formed with an arc structure, the fastening seat and the end cap are formed with an arc structure respectively. Moreover, the arc structures at both ends of the sleeve are engaged with the arc structure of the fastening seat and the arc structure of the end cap respectively, in such a manner that the axial displacement angle of the sleeve between the fastening seat and the end cap can be adjusted, thus adjusting the angle of the stopwatch mounted on the sleeve. Consequently, though in the reflection condition, what is shown on the stopwatch still can be seen distinctly.

In addition, the arc structure at one end of the sleeve can be an outwards protruded arc surface, while the arc structure of the fastening seat is a concave arc surface. Otherwise, the arc structure at one end of the sleeve is an inwards concave arc surface, while the arc structure of the fastening seat is a protruded arc surface.

Moreover, the arc structure at the other end of the sleeve can be an outwards protruded arc surface, while the arc structure of the end cap is a concave arc surface; otherwise, the arc structure at the other end of the sleeve is an inwards concave arc surface, while the arc structure of the end cap is a protruded arc surface.

### BRIEF DESCRIPTION OF THE DRAWINGS

FIG. 1 is an exploded view of a conventional stopwatch supporter;

FIG. 2 shows that an angle adjustable stopwatch supporter assembled with a stopwatch in accordance with the prevent invention is mounted on a handlebar of a bicycle;

FIG. 3 is an exploded view of the angle adjustable stopwatch supporter in accordance with the prevent invention;

FIG. 4 is a cross sectional view of the angle adjustable stopwatch supporter in accordance with the prevent invention;

FIG. 5 is a cross sectional view of a sleeve adjusted at an angle in accordance with the prevent invention; and

FIG. 6 an exploded view of a fastening seat is integral with a fixed seat in accordance with the present invention.

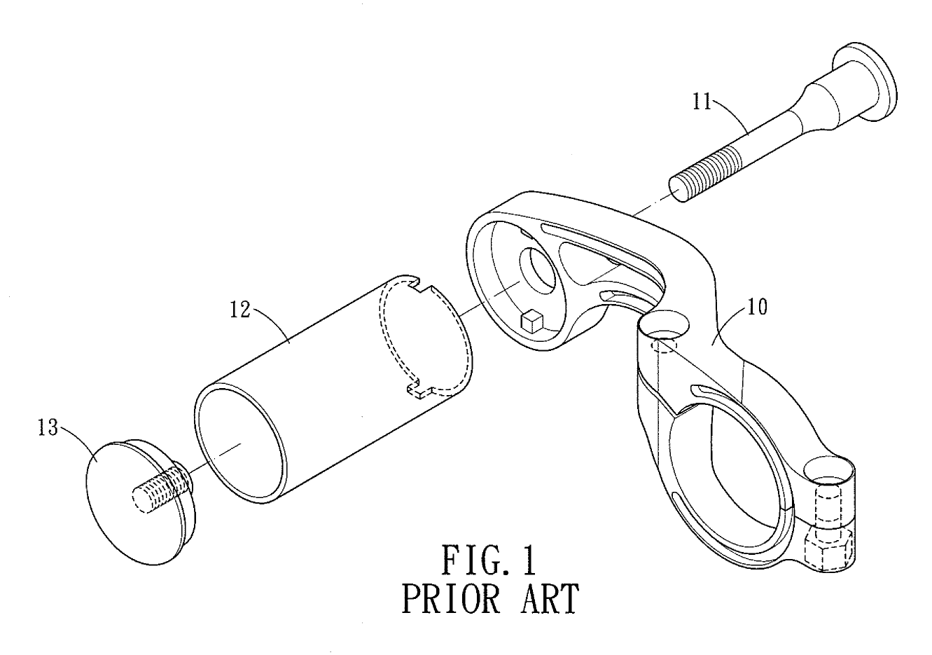

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

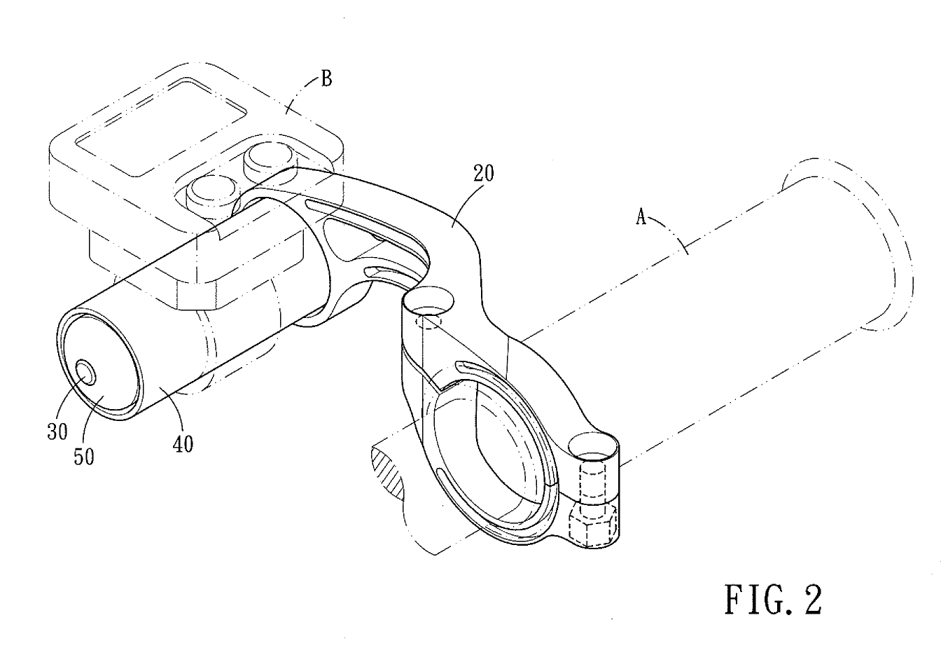

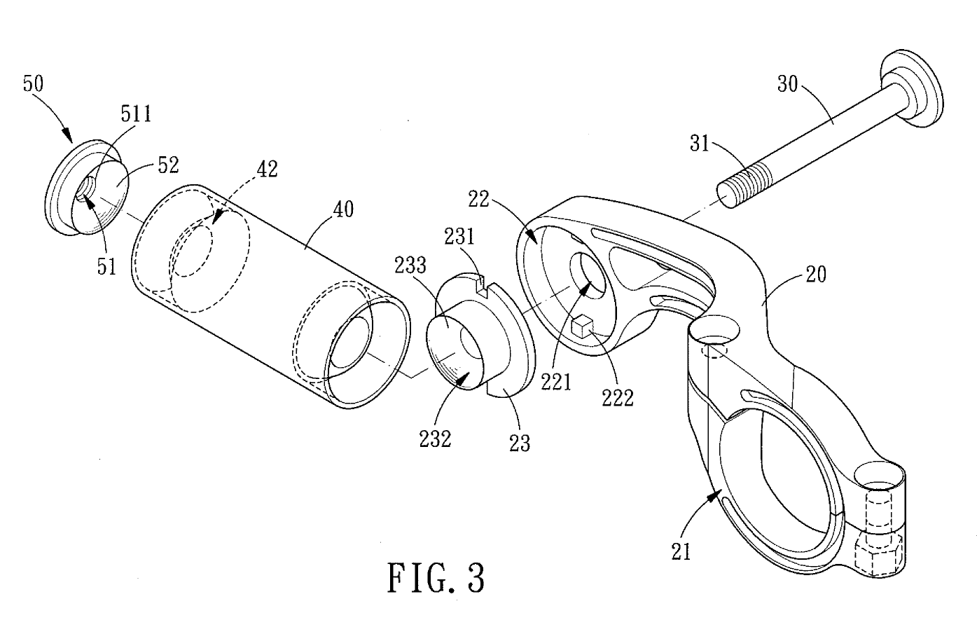

Referring to FIGS. 2-3, an angle adjustable stopwatch supporter assembled on the handlebar of a bicycle in accordance with a preferred embodiment of the present invention comprises a fastening seat 20, a fixed shaft 30, a sleeve 40 and an end cap 50.

The fastening seat 20 is provided with a fastener 21 on one end thereof and a recess 22 on the other end thereof The fastening seat 20 can be positioned on the handlebar A of the bicycle by the engagement of the fastener 21, in the bottom of the recess 22 is defined a through hole 221, and two opposite protuberant blocks 222 are formed on the inner surface of the recess 22. The fastening seat 20 further includes a fixed seat 23 disposed in the recess 22, and the fixed seat 23 is formed with two gaps 231 to be engaged with the protuberant blocks 222, a through hole 232 aligned with the through hole 221, and an arc structure 233.

The fixed shaft 30 has one end inserted into the through holes 221, 232 of the fastening seat 20 and the fixed seat 23, and on the outer surface of this end of the fixed shaft 30 are formed outer threads 31.

The end of the fixed shaft 30 with the outer threads 31 is inserted through the sleeve 40, and one end of the sleeve 40 is positioned in the recess 22 of the fastening seat 20. Additionally, the inner diameter of the recess 22 is bigger than the outer diameter of the sleeve 40. The sleeve 40 is further formed with a first arc structure 41 engaged in the arc structure 233 of the fixed seat 23 of the fastening seat 20 at one end positioned in the recess 22 and a second arc structure 42 at the other end thereof. A stopwatch B is fastened on the outer surface of the sleeve 40.

The end cap 50 is formed with a through hole 51 with inner threads 511. The end cap 50 is screwed on the fixed shaft 30 by the cooperation of the inner threads 511 and the outer threads 31, so as to position the sleeve 40 between the fastening seat 20 and the end cap 50 formed with an arc structure 52. The end cap 50arc structure 50 is positioned against the second arc structure 42 of the sleeve 40 by arc structure 52.

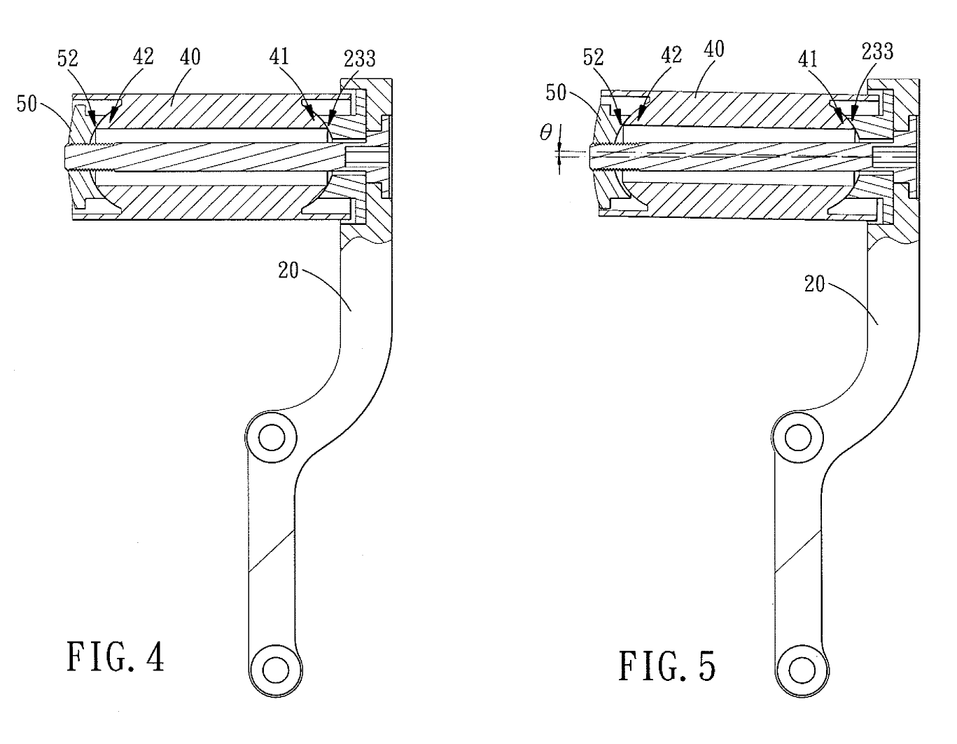

The angle adjustable stopwatch supporter in accordance with the present invention is shown in FIG. 4, since the sleeve 40 utilizes the first arc structure 41 and the second arc structure 42 to position against the arc structure 233 of the fastening seat 23 and the arc structure 52 of the end cap 50 respectively, with the first arc structure 41 and the second arc structure 42, the sleeve 40 can slide between the arc structure 233 of the fastening seat 23 and the arc structure 52 of the end cap 50, thus presenting the state shown in FIG. 5. When the axial displacement angle of the sleeve 40 positioned between the fastening seat 20 and the end cap 50 is adjusted, the angle of the stopwatch B is adjusted. So the players can see what is shown on the stopwatch B distinctly without the influence of the reflected sunlight. Moreover, since the inner diameter of the recess 22 is bigger than the outer diameter of the sleeve 40, it provide an enough space for the axial displacement of the sleeve 40.

As for the angle adjustable stopwatch supporter of the preferred embodiment in accordance with the present invention, the first arc structure 41 of the sleeve 40 is an outwards protruded arc surface; the arc structure 233 of the fixed seat 23 is a concave arc surface. Otherwise, the first arc structure 41 of the sleeve 40 can also be a concave arc surface; the arc structure 233 of the fixed seat 23 can also be an outwards protruded arc surface.

Additionally, the second arc structure 41 of the sleeve 40 in accordance the preferred embodiment is an outwards protruded arc surface, the arc structure 52 of the end cap 50 is a concave arc surface. Otherwise, the second arc structure 41 of the sleeve 40 can also be a concave arc surface; the arc structure 52 of the end cap 50 can also be an outwards protruded arc surface.

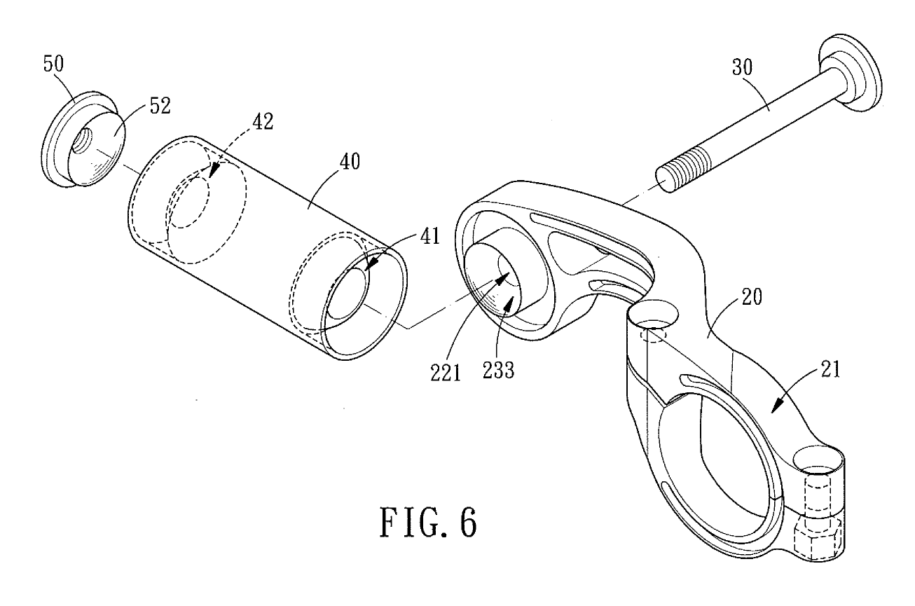

Moreover, further referring to the FIG. 6, the arc structure 233 and the through hole 221 are integrally and directly formed on the fastening seat 20, which can achieve the same function and objective.

To summarize, the angle adjustable stopwatch supporter of the present invention comprises a fastening seat, a fixed shaft, a sleeve and an end cap. The sleeve and the end cap are positioned on the fastening seat by the fixed shaft, each end of the sleeve is provide with an arc structure, likewise, the fastening seat and the end cap are formed with an arc structure respectively. The two arc structures of the sleeve are engaged with the arc structures of the fastening seat and the end cap respectively, so as to adjust the axial displacement angle between the fastening seat and the end cap.

While we have shown and described various embodiments in accordance with the present invention, it is clear to those skilled in the art that further embodiments may be made without departing from the scope of the present invention.

What is claimed is:

1. An angle adjustable stopwatch supporter comprising a fastening seat, a fixed shaft, a sleeve and an end cap, the fixed shaft being inserted through the fastening seat and the sleeve and being assembled with the end cap, characterized in that:
both ends of the sleeve are formed with a first arc structure and a second structure respectively, likewise, the fastening seat and the end cap are formed with an arc structure respectively, the first arc structure of the sleeve is engaged with the arc structure of the fastening seat, and the second arc structure of the sleeve is engaged with the arc structure of the end cap.

2. The angle adjustable stopwatch supporter as claimed in claim 1, wherein the first arc structure of the sleeve is an outwards protruded arc surface, the arc structure of the fastening seat is a concave arc surface.

3. The angle adjustable stopwatch supporter as claimed in claim 1, wherein the first arc structure of the sleeve is a concave arc surface, the arc structure of the fastening seat is an outwards protruded arc surface.

4. The angle adjustable stopwatch supporter as claimed in claim 1, wherein the second arc structure of the sleeve is an outwards protruded arc surface, the arc structure of the end cap is a concave arc surface.

5. The angle adjustable stopwatch supporter as claimed in claim 2, wherein the second arc structure of the sleeve is an outwards protruded arc surface, the arc structure of the end cap is a concave arc surface.

6. The angle adjustable stopwatch supporter as claimed in claim 3, wherein the second arc structure of the sleeve is an outwards protruded arc surface, the arc structure of the end cap is a concave arc surface.

7. The angle adjustable stopwatch supporter as claimed in claim 1, wherein the second arc structure of the sleeve is an inwards concave arc surface, the arc structure of the end cap is a protruded arc surface.

8. The angle adjustable stopwatch supporter as claimed in claim 2, wherein the second arc structure of the sleeve is an inwards concave arc surface, and the arc structure of the end cap is a protruded arc surface.

9. The angle adjustable stopwatch supporter as claimed in claim 3, wherein the second arc structure of the sleeve is an inwards concave arc surface, and the arc structure of the end cap is a protruded arc surface.

10. The angle adjustable stopwatch supporter as claimed in claim 1, wherein one end of the fastening seat is formed a fastener, and the fastening seat is assembled on a handlebar of a bicycle by the fastener.

11. The angle adjustable stopwatch supporter as claimed in claim 1, wherein the fastening seat includes a fixed seat formed with the arc structure of the fastening seat.
